(19) United States
(12) Patent Application Publication
(10) Pub. No.: US 2026/0182571 A1
(43) Pub. Date: Jul. 2, 2026

(54) A MEDETOMIDINE CONTAINING PARTICLE AND USE THEREOF

(71) Applicant: I-TECH AB, Mölndal (SE)

(72) Inventors: Ida FRIBERG, Västra Frölunda (SE); Dan ISAKSSON, Mölndal (SE); Markus HOFFMANN, Sant Cugat Del Vallès (ES)

(21) Appl. No.: 19/125,511

(22) PCT Filed: Nov. 1, 2023
(86) PCT No.: PCT/EP2023/080456

§ 371 Date: Apr. 29, 2025

(30) Foreign Application Priority Data
Nov. 4, 2022 (EP) 22205615.2

(51) Int. Cl. A01N 43/50; A01N 25/12; A01P 15/00

(52) U.S. Cl. CPC A01N 43/50; A01N 25/12; A01P 15/00

(57) ABSTRACT

A solid particle comprising a coprecipitate of a metal or metalloid compound, and medetomidine or an enantiomer or salt of medetomidine, an antifouling and an antifouling paint formulation containing such particle, an antifouling coating obtained by use of the paint formulation, and an object having the coating on at least part of its surface. A method for preparing the particle and the formulation.

### FIELD OF THE INVENTION

The present invention relates generally to a new medetomidine containing product useful as an antifouling agent, to a method for preparing such product and to the use of such product, e.g., as an additive in, for example marine paints.

### BACKGROUND OF THE INVENTION

Biofouling is a natural process that involves the accumulation and growth of microorganisms, algae, plants and small animals on any natural or artificial wetted surface, often resulting in severe economic disturbances to the marine as well as other aquatic industries. For example, attachment of organisms such as barnacles, algae, tube worms and the like to ship hulls reduces fuel efficiency and causes loss of profitable time because of the need of regular cleaning of the hulls, while attachment of such organisms to cooling water equipment decreases heat conductivity, which eventually reduces the cooling power of the equipment and drives up costs. Significant problems with marine biofouling also exist in installations such as aqua culture equipment, marine sensors, marine renewable energy installations and floating devices, and oil/gas off-shore installations.

Antifouling strategies have been devised to combat biofouling, such as antifouling paints and coatings of various types. Biocidal antifouling paints are paint coatings that repel the biofouling organisms by creating a bioactive boundary layer in the immediate vicinity of the coated surface. One type of antifouling paints are biocide-releasing antifouling paints which can be generally divided into three main categories: contact leaching coatings, controlled depletion polymer (CDP) coatings and self-polishing copolymer (SPC) coatings, all of which are based on the controlled and slow release of bioactive molecules incorporated in a polymeric matrix.

Contact leaching coatings rely on high molecular weight polymeric matrices that are insoluble in seawater, made from polymers such as acrylics, epoxy, vinyl polymers or chlorinated rubber polymers. The bioactive compounds present in the matrix are released to the surrounding environment, creating pores that allow water to penetrate the coating and thereby dissolve more of the bioactive compound. CDP coatings are soluble matrix paints containing biocides mixed with water-soluble binders. Usually, these paints are formulated using a blend of relatively fast dissolving natural rosin and more slowly dissolving synthetic organic resins, that control the hydration and dissolution of the soluble binder. As water passes across the surface of the coating, the soluble binder and the incorporated biocide are dissolved and released together. SPC coatings are based on a polymeric binder to which leaving group moieties are chemically bound, and from which leaving group bonds to the polymer backbone are gradually hydrolysed by water, whereby the water-soluble or water-dispersible polymer matrix at the surface of the coating layer is washed out or eroded. Examples of self-polishing antifouling paint systems are silyl ester copolymer-based paints.

There are also antifouling coatings that essentially do not function by releasing biocide, the so-called foul release coatings (FRC), which basically function by providing a low-friction and ultra-smooth surface that prevents attachment of biofoulants, as well as facilitating the detachment of any attached biofoulant from the surface under the shear flow caused by the movement of the ship. These types of coatings are mainly based on fluoropolymers and silicones.

As active biocide in antifouling formulations, various compounds are known in the prior art, including e.g., copper (I) oxide, copper (I) thiocyanate, copper (II) pyrithione, zinc (II) pyrithione, DCOIT (4,5-dichloro-2-n-octyl-4-isothiazolin-3-one), tralopyril (4-bromo-2-(4-chlorophenyl)-5-(trifluoromethyl)-1H-pyrrole-3-carbonitrile) and zineb (zinc ethane-1,2-diylbis(dithiocarbamate)). Often, antifouling paint formulations contain more than one of these biocides, e.g., 2, 3 or 4 biocidal compounds are used in combination. Nominal biocidal concentrations (average±standard deviation) in antifouling paint formulations have been reported for example, 35.9±12.8% w/w of copper (I) oxide, and 18.1±8.02% w/w of copper (I) thiocyanate.

A further biocidal compound, having efficacy against barnacle biofouling of marine surfaces, is the compound medetomidine, having the chemical name (±)-4-[1-(2,3-dimethylphenyl)ethyl]-1H-imidazole (or (±)-5-[1-(2,3-dimethylphenyl)ethyl]-1H-imidazole, also named (RS)-4-[1-(2,3-dimethylphenyl)ethyl]-3H-imidazole). Medetomidine is an alpha (2)-adrenoceptor agonist and has been found to inhibit the settling process of barnacle larvae, which renders it useful as an antifouling agent in paint formulations.

Generally, the most established way of formulating an antifouling paint with medetomidine is to add the medetomidine to the wet paint as a dry powder or as a solution together with a solvent. For this method, the medetomidine is preferably added early in the paint making process when the probability of the medetomidine adsorbing onto the surface of any other paint component, such as a pigment, is high. Later in the process, most potential adsorption sites for medetomidine will already be occupied by other molecules; at that point the probability of the medetomidine adsorbing on anything will be low and the compound will therefore mostly remain free in the wet paint.

However, if the medetomidine is not adsorbed on any carrier, there is a high risk of the medetomidine leaching from the paint matrix more rapidly than preferred, thus only providing short term fouling protection. Moreover, free medetomidine can lead to a reduced in-can stability of the wet paint. Indeed, free organic biocides, such as medetomidine, may promote increased viscosity (gelling) of paint binders having ester and/or silyl esters functional groups as part of the polymer chain, and this not only may shorten the shelf life but also influence the self-polishing and antifouling performance of the paint systems.

One prior art method to control the release rate of medetomidine from dry coatings is described in U.S. Pat. No. 7,311,766. In that method, ready-made nanoparticles of various common paint pigments are added to a medetomidine/o-xylene solution, allowing for adsorption of medetomidine onto the surface of the nanoparticles, whereafter the nanoparticles with the adsorbed medetomidine can be admixed with the other paint components, to provide a paint formulation having prolonged antifouling efficiency.

There remains a need for a marine antifouling additive that is easy to produce and that provides a high and prolonged antifouling efficiency. There is also a need for an antifouling paint formulation having a suitable in-can stability (shelf life) and that, when added to a paint formulation, will not unduly reduce the shelf life thereof. In particular, it would be a great advantage to provide a paint formulation having a sufficient in-can stability and that, when applied as a coating to a surface in a marine environment, is capable of providing a prolonged antifouling effect, e.g., against barnacle attachment.

### SUMMARY OF THE INVENTION

A first aspect is a particle comprising a coprecipitate of:
(i) a metal or metalloid compound, and
(ii) medetomidine or an enantiomer or salt of medetomidine.

A further aspect is a method for preparing a solid particle containing medetomidine or an enantiomer or salt of medetomidine, by coprecipitation of (i) a metal or metalloid compound, and (ii) medetomidine or an enantiomer or salt of medetomidine.

The medetomidine formulation provided herein is different from the one disclosed in U.S. Pat. No. 7,311,766, which describes ready-made pigment particles with biocides adsorbed on their surfaces. By contrast, the invention herein concerns particles with medetomidine incorporated within the particle matrix.

The prepared medetomidine-containing particles can be added as an antifouling additive to any type of paint formulations, for example silicon-based FRC formulations and/or silyl acrylate-based SPC formulations. Due to the biological effect of medetomidine, the particle of the invention may be used in particular against barnacle fouling of any solid surface in contact with an aquatic environment where barnacles may grow, such as in sea water.

A still further aspect is an antifouling additive comprising a particle as defined herein or prepared by a method as disclosed herein, and optionally a liquid carrier.

When added to a wet paint, the antifouling additive of the invention limits the concentration of free medetomidine molecules in the wet paint, since most of the medetomidine remains within the particles. This results in lower probability of undesired interactions and/or reactions of free medetomidine with other paint components, and thereby may lead to an improved shelf life and self-polishing and antifouling performance of the paint systems. Furthermore, binders having ester and/or silyl ester functional groups can be combined with the medetomidine-containing particle of the invention with improved preservation of in-can stability of the wet paint formulation.

A still further aspect is an antifouling coating composition comprising a particle as disclosed herein or prepared by a method as defined herein, and a surface coating material.

A still further aspect is an antifouling coating composition comprising an antifouling additive as defined herein or prepared by a method as disclosed herein, and surface coating material.

A still further aspect is an antifouling coating film formed from an antifouling coating as disclosed herein.

A still further aspect is a method for preventing marine biofouling of a surface by applying an antifouling coating formulation to said surface or in the vicinity of said surface.

A still further aspect is an object, such as a ship, boat, a marine sensor, a floating device, a buoy, a fish cage etc. having an antifouling coating according to the invention on at least part of its surface.

The use of the medetomidine formulation of the invention, provides for a reduced leach rate of medetomidine from the coating matrix, which is associated to long-lasting barnacle protection of the coating surface. This effect is particularly important for silicone-based FRC. Hence the invention further comprises a novel method to improve the protective effect of FRC and other types antifouling coatings against barnacle settlement.

Further aspects and embodiments thereof, as well as advantages linked to the present invention, will be apparent from the following detailed description and will be illustrated by the non-limitative examples provided herein.

### BRIEF DESCRIPTION OF DRAWINGS

FIG. 1 shows photos of silicone-based foul release coatings (FRC) after 71 days submersion in the sea, at Tjärnö, Sweden. Top field: undamaged, middle field: cross cut with knife, bottom field: roughened with sand paper. From left to right: 0.1% medetomidine added as solution, 0.1% medetomidine incorporated within zinc (II) oxide (ZnO) and 0.1% medetomidine incorporated within copper (II) pyrithione (CuPT).

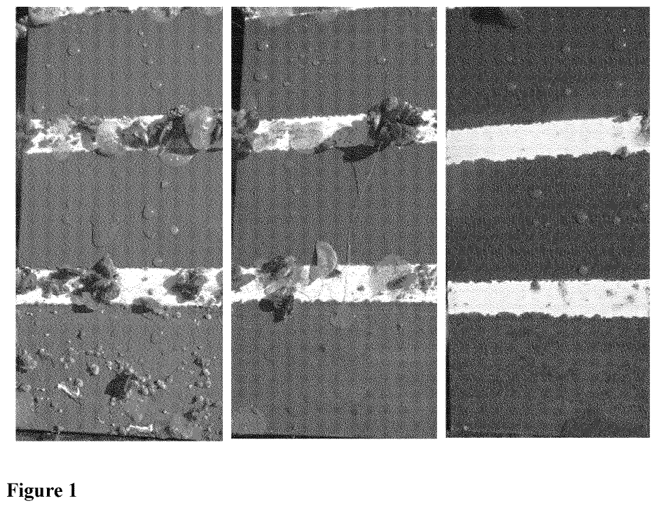

FIG. 2 is a graph showing the viscosity of the silyl acrylate-based coating formulations in Example 4 as a function of time, i.e. formulations A (−), B (□), C (x), D (Δ), E (•), F (▴), G (∘) and H (♦). The medetomidine concentration in formulations B, C, E, and G was 0.3 wt. %. The other samples did not contain medetomidine.

FIG. 3 is a graph showing the viscosity of the silyl acrylate-based coating formulations in Example 5 as a function of time, i.e. formulations I (−), J (□), K (•), L (⋄), M (♦), N (▴) and O (▪). The medetomidine concentration in formulations J, K, L, M, N and O was 0.3 wt. %. Formulations I did not contain medetomidine.

### DETAILED DESCRIPTION

It should be appreciated that the invention may be embodied in different forms and should not be construed as limited to the embodiments set forth herein. Rather, these embodiments are provided so that this disclosure will be thorough and complete, and will fully convey the scope of the invention to one of ordinary skill in the art.

The one of ordinary skill in the art will understand that terminology used in the description herein is for the purpose of describing particular embodiments only and is not intended to be limiting of the invention. Unless otherwise defined, all terms, including technical and scientific terms used in the description, have the same meaning as commonly understood by one of ordinary skill in the art to which this invention belongs.

As used herein, the singular forms “a”, “an”, and “the” are intended to include the plural forms as well, unless the context clearly indicates otherwise. Thus, such references may be replaced with a reference to “one or more”, e.g., one, of the relevant component or integer. As used herein, all references to “one or more” of a particular component or integer will be understood to refer to from one to a plurality, e.g., two, three or four, of such components or integers. It will be understood that references to “one or more” of a particular component or integer will include a particular reference to one such integer.

As used herein, “and/or” refers to and encompasses any and all possible combinations of one or more of the associated listed items.

The term “about”, as used herein when referring to a measurable value, such as an amount of a compound, dose, time, temperature, and the like, refers to variations of 20%, 10%, 5%, 1%, 0.5%, or even 0.1% of the specified amount. When a range is employed, e.g., a range from x to y, it is it meant that the measurable value is a range from about x to about y, or any range or value therein including x and y. It will be further understood that the terms “comprises” and/or “comprising,” and similar expressions, such as “contains”, “includes”, “containing” etc, when used in this specification, specify the presence of stated features, integers, steps, operations, elements, components and/or groups, but do not preclude the presence or addition of one or more other features, integers, steps, operations, elements, components, and/or groups thereof, unless otherwise specified or apparent from the context.

As used herein, a “surface coating material” or a “coating material” or similar expressions refer to a material, or compound or composition which adheres to a surface to provide a coating on the same. Surface coating materials are well known in the field of paints.

“Effective” as used herein, e.g., with respect to an amount of a compound, composition and/or formulation, means sufficient to produce a desired effect.

All patents, patent applications and publications referred to herein are incorporated by reference in their entirety. In the event of conflicting terminology, the present specification is controlling, unless otherwise clearly apparent from the context.

The present embodiments relate to particles with medetomidine incorporated within. This is different from the teaching of U.S. Pat. No. 7,311,766, which describes ready-made pigment particles with biocides adsorbed on their surfaces. By contrast, the invention herein concerns particles with biocides incorporated within the particle matrix.

The present invention is based on the use of medetomidine, or an enantiomer or salt thereof, as a biocide present in the matrix of a solid particle, such as a pigment particle.

As used herein, the term medetomidine, refers to the compound (±)-4-[1-(2,3-dimethylphenyl)ethyl]-1H-imidazole (which may also be referred to as, for example, (±)-5-[1-(2,3-dimethylphenyl)ethyl]-1H-imidazole, or (RS)-4-[1-(2,3-dimethylphenyl)ethyl]-3H-imidazole etc.) having the structural formula

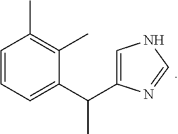

Unless otherwise specified or apparent from the context, the term medetomidine also includes a salt thereof, or an enantiomer thereof, or a salt of an enantiomer thereof.

### The Medetomidine-Containing Particle

A first aspect a solid particle comprising a coprecipitate of:
(i) a metal or metalloid compound (“component (i)”), and
(ii) medetomidine or an enantiomer or salt of medetomidine.

The metal of component (i) may be, for example, a metal capable of forming multivalent salts or oxides, for example, selected from alkaline earth metals and transition metals, such as Mg, Ca, Ba, Ti, Fe, Cu, Zn, and Al.

Metalloids are chemical elements with physical and chemical properties that are in between those properties of chemical elements defined as metals and non-metals. The metalloid of component (i) may be, for example, Si. Preferably, component (i) is not unduly toxic for the environment at the level of use.

The metal or metalloid compound may be, for example, an oxide, a salt or a coordination complex; e.g., an oxide, a pyrithione, a thiocyanate, a sulfate, a carboxylate, or a carbonate.

In some embodiments, component (i) is a metal compound, such as a metal oxide, a metal salt or a metal coordination complex; e.g., a metal oxide, a metal pyrithione, a metal thiocyanate, a metal sulfate, a metal carboxylate, or a metal carbonate.

Non-limitative examples of metal and metalloid compounds for use herein include: zinc (II) oxide, iron (II) oxide, iron (III) oxide, copper (I) oxide, copper (II) oxide, titanium (IV) oxide, silicon (IV) oxide, copper (II) pyrithione, zinc (II) pyrithione, copper (I) thiocyanate, barium (II) sulfate, calcium (II) sulfate, magnesium (II) carbonate, calcium (II) carbonate, barium (II) carbonate, iron (II) carbonate, zinc (II) carbonate, and/or metal salts of C2-C24 carboxylic acids.

In some embodiments, the metal and metalloid compounds for use herein include: zinc (II) oxide, iron (II) oxide, iron (III) oxide, copper (I) oxide, copper (II) oxide, titanium (IV) oxide, copper (II) pyrithione, zinc (II) pyrithione, copper (I) thiocyanate, calcium (II) sulfate, barium (II) sulfate, barium (II) oxalate, magnesium (II) carbonate, calcium (II) carbonate, barium (II) carbonate, iron (II) carbonate, zinc (II) carbonate and/or silicon (IV) oxide.

In some embodiments, the metal or metalloid compound more particularly is a metal compound selected from zinc (II) oxide, copper (I) oxide, copper (II) pyrithione, and barium (II) sulfate.

In some embodiments, the metal compound is a metal oxide, e.g., a metal oxide as exemplified herein above. In some embodiments, component (i) is a multivalent metal oxide, e.g., a divalent metal oxide, such as copper (II) oxide (CuO), or zinc (II) oxide (ZnO).

In some embodiments, the metal oxide is copper (I) oxide or copper (II) oxide. In some embodiments, the metal oxide is copper (I) oxide.

In some embodiments, the component (i) is a metal salt, e.g., a metal salt as exemplified herein. In some embodiments, when the metal compound is a metal salt, the metal salt is selected from multivalent metal salts, such as CuPT and barium (II) sulfate (BaSO₄). In some embodiments, when the metal compound is a metal salt, the metal salt is CuPT. In some other embodiments, when the metal compound is a metal salt, the metal salt is BaSO₄.

In some embodiments, the metal compound is selected from CuPT, ZnO, and BaSO₄.

In some embodiments, the metal compound is a metal pyrithione, e.g., zinc (II) pyrithione (ZnPT) or CuPT. In CuPT and ZnPT, respectively, a divalent metal (Cu (II) or Zn (II)), and two 2-thioxopyridin-1(2H)-olate moieties form a compound of formula

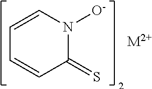

wherein M denotes either Zn or Cu.

While referred to herein as metal salts, the pyrithiones may also be referred to as metal coordination complexes or coordination compounds, which could be represented by the formula

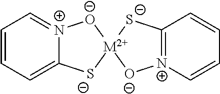

where, again, M denotes either Zn or Cu.

Thus, in the present context, the reference to a metal salt may also include a metal coordination complex, i.e. component (i) may be selected from a metal oxide, a metal salt, and a metal coordination complex.

In some embodiments, the metal compound for use herein is copper (I) thiocyanate, also sometimes referred to as copper (I) thiocyanate. Copper (I) thiocyanate is a coordination polymer with the chemical formula CuSCN.

Other types of metal salts include salts with carboxylic acids, e.g., C2-C24 carboxylic acids, such as C2-C20 carboxylic acids, C2-C16 carboxylic acids, C2-C12 carboxylic acids, C2-C8 carboxylic acids, or C2-C6 carboxylic acids, including mono-, and polycarboxylic acids, e.g., mono-, di-, and tricarboxylic acids, for example, oxalic acid.

In some embodiments, the component (i) in itself may have a biocidal effect, which may serve to strengthen the overall antifouling effect of the medetomidine.

By coprecipitating with medetomidine, component (i) will form a matrix in which the medetomidine is contained. Component (i) is preferably somewhat water soluble so that it dissolves over time when submerged in water, for example sea water. The incorporated medetomidine gradually gets exposed to the water as the matrix formed by component (i) dissolves and the medetomidine is released along with the dissolution of the matrix containing it. The released medetomidine will thereby become available at the surface and/or in the vicinity of the surface of the antifouling coating of the invention, to prevent or at least significantly reduce adhesion and growth of barnacles on the coated surface as well as on surfaces in the vicinity of the coating.

The water solubility of the metal or metalloid compound forming the medetomidine-containing matrix is preferably low. In particular, the water solubility of the compound preferably is such that the compound can be prepared by precipitation in water and/or other polar solvents and/or a mixture of water and other polar solvents. It is also preferred that the water solubility is such that when in contact with water, the dissolution of the matrix progresses slowly over time so that medetomidine is released from the coating during the entire lifetime of the coating. It should be understood that the total medetomidine release from the coating also depends on other factors such as the water permeability through the coating, polishing rate of the coating surface and/or erosion of the coating surface. The coating containing the medetomidine-containing particle must allow for some water to get into contact with said particle in order to enable dissolution of particle matrix and release of medetomidine.

A water solubility of the matrix formed by component (i) higher than preferred may result in too fast dissolution of the matrix when the coating is submerged in water. This means increased water exposure of the medetomidine and thereby high leach rate of medetomidine from the coating. Hence, a high aqueous solubility of component (i) entails a risk of premature medetomidine depletion when the coating is submerged in water. Thus, the metal or metalloid compound (salt, including coordination and complex compounds, or oxide) used according to the present invention preferably has a low water solubility, a water solubility of at most 150 mg/l, at most 125 mg/L, at most 100 mg/L, at most 75 mg/L, at most 50 mg/L, at most 40 mg/L, at most 30 mg/L, at most 25 mg/L, at most 20 mg/L, at most 15 mg/L, at most 10 mg/L, at most 8 mg/L, at most 5 mg/L, at most 4 mg/L, at most 3 mg/L, at most 2 mg/L, or at most 1 mg/L (equilibrium solubility as measured at pH 7 and 20° C.).

Preferably the water solubility of component (i) is not too low, since this could lead to a medetomidine leach rate that is too low, which may affect the antifouling efficiency. Thus, the metal or metalloid compound used according to the present invention preferably has a water solubility of at least 0.01 mg/L, at least 0.02 mg/L, at least 0.05 mg/L, at least 0.08 mg/L, at least 0.1 mg/L, at least 0.2 mg/L, at least 0.3 mg/L, at least 0.4 mg/L, at least 0.5 mg/L, at least 0.6 mg/L, at least 0.7 mg/L, at least 0.8 mg/L, at least 0.9 mg/L, or at least 1 mg/L (equilibrium solubility as measured at pH 7 and 20° C.).

In some embodiments, component (i) has a water solubility in the range from 0.01 mg/L to 150 mg/L, e.g., from 0.01 mg/L to 125 mg/L, from 0.01 mg/L to 100 mg/L, from 0.01 mg/L to 75 mg/L, from 0.01 mg/L to 50 mg/L, from 0.01 mg/L to 40 mg/L, from 0.01 mg/L to 30 mg/L, from 0.01 mg/L to 25 mg/L, from 0.01 mg/L to 20 mg/L, from 0.01 mg/L to 15 mg/L, from 0.01 mg/L to 10 mg/L, from 0.01 mg/L to 8 mg/L, or from 0.01 mg/L to 5 mg/L.

In some embodiments, component (i) has a water solubility in the range from 0.02 mg/L to 150 mg/L, e.g., from 0.02 mg/L to 125 mg/L, from 0.02 mg/L to 100 mg/L, from 0.02 mg/L to 75 mg/L, from 0.02 mg/L to 50 mg/L, from 0.02 mg/L to 40 mg/L, from 0.02 mg/L to 30 mg/L, from 0.02 mg/L to 25 mg/L, from 0.02 mg/L to 20 mg/L, from 0.02 mg/L to 15 mg/L, from 0.02 mg/L to 10 mg/L, from 0.02 mg/L to 8 mg/L, or from 0.02 mg/L to 5 mg/L.

In some embodiments, component (i) has a water solubility in the range from 0.05 mg/L to 150 mg/L, e.g., from 0.05 mg/L to 125 mg/L, from 0.05 mg/L to 100 mg/L, from 0.05 mg/L to 75 mg/L, from 0.05 mg/L to 50 mg/L, from 0.05 mg/L to 40 mg/L, from 0.05 mg/L to 30 mg/L, from 0.05 mg/L to 25 mg/L, from 0.05 mg/L to 20 mg/L, from 0.05 mg/L to 15 mg/L, from 0.05 mg/L to 10 mg/L, from 0.05 mg/L to 8 mg/L, or from 0.05 mg/L to 5 mg/L.

In some embodiments, component (i) has a water solubility in the range from 0.08 mg/L to 150 mg/L, e.g., from 0.08 mg/L to 125 mg/L, from 0.08 mg/L to 100 mg/L, from 0.08 mg/L to 75 mg/L, from 0.08 mg/L to 50 mg/L, from 0.08 mg/L to 40 mg/L, from 0.08 mg/L to 30 mg/L, from 0.08 mg/L to 25 mg/L, from 0.08 mg/L to 20 mg/L, from 0.08 mg/L to 15 mg/L, from 0.08 mg/L to 10 mg/L, from 0.08 mg/L to 8 mg/L, or from 0.08 mg/L to 5 mg/L.

In some embodiments, component (i) has a water solubility in the range from 0.1 mg/L to 150 mg/L, e.g., from 0.1 mg/L to 125 mg/L, from 0.1 mg/L to 100 mg/L, from 0.1 mg/L to 75 mg/L, from 0.1 mg/L to 50 mg/L, from 0.1 mg/L to 40 mg/L, from 0.1 mg/L to 30 mg/L, from 0.1 mg/L to 25 mg/L, from 0.1 mg/L to 20 mg/L, from 0.1 mg/L to 15 mg/L, from 0.1 mg/L to 10 mg/L, from 0.1 mg/L to 8 mg/L, or from 0.1 mg/L to 5 mg/L.

In some embodiments, component (i) has a water solubility in the range from 0.2 mg/L to 150 mg/L, e.g., from 0.2 mg/L to 125 mg/L, from 0.2 mg/L to 100 mg/L, from 0.2 mg/L to 75 mg/L, from 0.2 mg/L to 50 mg/L, from 0.2 mg/L to 40 mg/L, from 0.2 mg/L to 30 mg/L, from 0.2 mg/L to 25 mg/L, from 0.2 mg/L to 20 mg/L, from 0.2 mg/L to 15 mg/L, from 0.2 mg/L to 10 mg/L, from 0.2 mg/L to 8 mg/L, or from 0.2 mg/L to 5 mg/L.

In some embodiments, component (i) has a water solubility in the range from 0.5 mg/L to 150 mg/L, e.g., from 0.5 mg/L to 125 mg/L, from 0.5 mg/L to 100 mg/L, from 0.5 mg/L to 75 mg/L, from 0.5 mg/L to 50 mg/L, from 0.5 mg/L to 40 mg/L, from 0.5 mg/L to 30 mg/L, from 0.5 mg/L to 25 mg/L, from 0.5 mg/L to 20 mg/L, from 0.5 mg/L to 15 mg/L, from 0.5 mg/L to 10 mg/L, from 0.5 mg/L to 8 mg/L, or from 0.5 mg/L to 5 mg/L.

In some embodiments, component (i) has a water solubility in the range from 0.8 mg/L to 150 mg/L, e.g., from 0.8 mg/L to 125 mg/L, from 0.8 mg/L to 100 mg/L, from 0.8 mg/L to 75 mg/L, from 0.8 mg/L to 50 mg/L, from 0.8 mg/L to 40 mg/L, from 0.8 mg/L to 30 mg/L, from 0.8 mg/L to 25 mg/L, from 0.8 mg/L to 20 mg/L, from 0.8 mg/L to 15 mg/L, from 0.8 mg/L to 10 mg/L, from 0.8 mg/L to 8 mg/L, or from 0.8 mg/L to 5 mg/L.

In some embodiments, component (i) has a water solubility in the range from 1 mg/L to 150 mg/L, e.g., from 1 mg/L to 125 mg/L, from 1 mg/L to 100 mg/L, from 1 mg/L to 75 mg/L, from 1 mg/L to 50 mg/L, from 1 mg/L to 40 mg/L, from 1 mg/L to 30 mg/L, from 1 mg/L to 25 mg/L, from 1 mg/L to 20 mg/L, from 1 mg/L to 15 mg/L, from 1 mg/L to 10 mg/L, from 1 mg/L to 8 mg/L, or from 1 mg/L to 5 mg/L.

By “water solubility” as used herein is meant the equilibrium water solubility. For example, the (equilibrium) water solubility of CuPT is less than 0.039 mg/L, that of ZnO is 1.6 mg/L, and that of BaSO₄ is 2.5 mg/L.

The content of medetomidine in the medetomidine-containing particle preferably is in the range of from 1 to 50% by weight of the particle, e.g., from 1 to 40% by weight, from 1 to 30% by weight, from 1 to 25% by weight, from 1 to 20% by weight, or from 1 to 15% by weight. In some embodiments, the medetomidine content is in the range of from 2 to 50% by weight of the particle, e.g., from 2 to 40% by weight, from 2 to 30% by weight, from 2 to 25% by weight, from 2 to 20% by weight, or from 2 to 15% by weight. In some embodiments, the medetomidine content is in the range of from 5 to 50% by weight of the particle, e.g., from 5 to 40% by weight, from 5 to 30% by weight, from 5 to 25% by weight, from 5 to 20% by weight, or from 5 to 15% by weight.

The size of the medetomidine-containing particle may range from nm-sized to μm-sized or even larger, e.g., the average particle diameter may be within a range of from about 5 nm to about 500 μm, e.g., about 10 nm to about 100 μm, about 50 nm to about 50 μm, or about 100 nm to about 10 μm, e.g., about 500 nm to about 5 μm.

In some embodiments, the metal compound of the medetomidine-containing particle is a compound useful as a pigment, in which case the medetomidine-containing particle may be referred to as a medetomidine-containing pigment particle.

As noted herein, medetomidine may be used either in its free base form or as a salt, e.g., an acid addition salt, such as a salt with a strong mineral acid, e.g., HCl.

### Method for Preparing the Medetomidine-Containing Particle

Also provided herein is a method for preparing a particle containing medetomidine or an enantiomer or salt of medetomidine, by coprecipitation of (i) a metal or metalloid compound (“component (i)”), and (ii) medetomidine or an enantiomer or salt of medetomidine (which may also collectively be referred to herein as “medetomidine”). The obtained particle will comprise a coprecipitate of medetomidine and component (i), the latter forming a “matrix” containing the medetomidine.

Coprecipitation of component (i) and medetomidine can be achieved by preparing a solution of the two components under conditions at which both components form a solution, followed by changing the conditions, e.g., by changing the solvent system, the solution pH, or the solution temperature, to cause the components to precipitate, to form a coprecipitate of the component (i) and medetomidine.

In some embodiments, component (i) is a metal compound as mentioned herein.

In some embodiments, the matrix for the medetomidine can be prepared by mixing two solutions of different soluble precursor compounds, e.g., precursor salts, forming a less soluble ion-pair that precipitates to form the matrix, and the medetomidine can be incorporated within the pigment matrix through coprecipitation of component (i) and medetomidine.

Coprecipitation may be achieved by dissolving medetomidine together with one or both of the precursor compounds, or by admixing a solution of medetomidine with one or both of the precursor compound solutions, to allow medetomidine to coprecipitate with the matrix-forming component (i).

Thus, in some embodiments, the method for preparing a solid particle comprising a coprecipitate of (i) a metal or metalloid compound as defined herein, and (ii) medetomidine or an enantiomer or salt of medetomidine comprises
admixing two liquid phase solutions of different salts in the presence of medetomidine or an enantiomer or salt of medetomidine, to form a metal or metalloid compound having a lower solubility in the liquid phase than either of said different salts, and
allowing said metal or metalloid compound and said medetomidine or enantiomer or salt of medetomidine to coprecipitate from the obtained liquid mixture.

In some embodiments, the medetomidine or enantiomer or salt of medetomidine is admixed with at least one of said liquid phase solutions, before admixing the solutions. In some embodiments the required amount of medetomidine is dissolved in a suitable liquid solvent or solvent mixture, e.g., an organic solvent or solvent mixture, such as xylene, ethanol, methanol and/or 1-methoxy-2-propanol and/or water, and the medetomidine-containing solution is admixed with at least one of the liquid phase solutions, before the admixing and coprecipitation.

The solvent used for the precipitation preferably is a polar solvent or mixture of several polar solvents. Preferably water is used and/or other polar solvents, for example, but not limited to, methanol, ethanol and/or 1-methoxy-2-propanol. The type and/or the blend of solvents, pH and/or the temperature may be adjusted to optimise the solubility of the components used for the coprecipitation. In some embodiments, precipitation is effected in an aqueous phase, e.g., in water.

It is considered well within the knowledge of the person of ordinary skill in the art to select the suitable components and reaction conditions to cause the desired metal or metalloid compound to form and precipitate. Information on suitable reactants and reaction conditions may, for example, be found in various textbooks, such as Reece H. Vallance, Douglas F. Twiss and Miss Annie R. Russell (1931). J. Newton Friend (ed.). A text-book of inorganic chemistry, Charles Griffin & Company Ltd.

For example, to obtain a desired metal oxide, a solution of a soluble salt of the metal of said oxide may be admixed with a solution of a strong base, such as aqueous NaOH. Likewise, to obtain a desired metal sulfate, a solution of a soluble salt of the metal of said sulfate may be admixed with a solution of a soluble sulfate salt, such as an aqueous solution of Na₂SO₄. To obtain a desired metal pyrithione, a solution of a soluble salt of the metal may be admixed with a solution of a soluble metal pyrithione, such as sodium pyrithione.

The precipitated medetomidine-containing particle may be separated from the solvent using any suitable separation method, for example, filtration, vacuum filtration, sedimentation, decantation, centrifugation, evaporation or any other separation method. The separated product may thereafter be dried, preferably within, but not limited to, the temperature range of 10 to 150° C.

### The Antifouling Additive

An antifouling additive is provided herein, comprising the medetomidine-containing particle of the invention, and optionally a liquid carrier. When present, the liquid carrier should be one in which the particle of the invention is essentially not soluble, at least for a period of time sufficient to allow for the antifouling additive to be mixed with the paint formulation. For example, the liquid carrier could be an organic solvent, such as xylene. In some embodiments, the antifouling additive does not include a liquid carrier, or is mixed with a liquid carrier before, e.g., immediately before, admixing the additive with the paint formulation. In some embodiments, the antifouling additive is a powder comprising the medetomidine-containing particle of the invention, optionally in admixture with one or more further dry ingredients, such as pigment particles and/or further biocidal agents.

The medetomidine-containing particle of the invention, or the antifouling additive containing said particle, may be added to a coating formulation, e.g., a wet paint formulation, which further can be applied onto maritime surfaces with risk of barnacle settlement.

For example, the particle of the invention can be added to any type of antifouling coating formulation, but preferably to an FRC formulation, a CDP formulation or an SPC formulation. Even more preferred, the particle can be added to a silicon-based FRC formulation and/or a silyl acrylate-based SPC formulation.

### The Antifouling Coating Formulation

An antifouling coating formulation is also provided herein, comprising the medetomidine-containing particle of the invention in a surface coating formulation. The surface coating formulation may comprise conventional ingredients, such as binders, water scavengers, pigments, plasticizers, and, optionally, additional biocides.

The antifouling coating formulation may be, for example a conventional contact leaching coating formulation, a CDP coating formulation, or an SPC coating formulation, such as a silyl acrylate-based SPC coating formulation, or an FRC formulation, such as a silicone-based FRC formulation, containing the particle of the invention. In some embodiments, the coating formulation is a CDP coating formulation, an SPC coating formulation, or an FRC formulation. In some embodiments, the coating formulation is an SPC coating formulation or an FRC formulation. In some embodiments, the coating formulation is an SPC coating formulation. In some embodiments, the coating formulation is an FRC formulation. Compositions of the aforementioned coating formulations are well known in the art, and the person of ordinary skill in the art will be capable of selecting the suitable ingredients, such as binders, water scavengers, pigments, plasticizers, and, optionally, additional biocides.

Non-limiting examples of biocides that can be used according to the embodiments include, but are not limited to, chlorothalonil (2,4,5,6-tetrachlorobenzene-1,3-dicarbonitrile), dichlofluanid (N-{[dichloro (fluoro) methyl] sulfanyl}-N′,N′-dimethyl-N-phenylsulfuric diamide), DCOIT (4,5-dichloro-2-n-octyl-4-isothiazolin-3-one), cybutryne (2-N-tert-butyl-4-N-cyclopropyl-6-methylsulfanyl-1,3,5-triazine-2,4-diamine), DCMU (3-(3,4-dichlorophenyl)-1,1-dimethylurea), tolylfluanid (N-[dichloro (fluoro) methyl] sulfanyl-N-(dimethylsulfamoyl)-4-methylaniline), zinc pyrithione (bis(2-pyridylthio) zinc 1,1′-dioxide), copper pyrithione (bis(2-pyridylthio) copper 1,1′-dioxide), copper thiocyanate, copper oxide, cybutryne (2-N-tert-butyl-4-N-cyclopropyl-6-methylsulfanyl-1,3,5-triazine-2,4-diamine), zineb (zinc ethane-1,2-diylbis(dithiocarbamate)), ziram (zinc bis(dimethyldithiocarbamates)), maneb (manganese ethylene-1,2-bisdithiocarbamate polymer), tralopyril (4-bromo-2-(4-chlorophenyl)-5-(trifluoromethyl)-1H-pyrrole-3-carbonitrile), and a mixture thereof.

To obtain an effective antifouling effect, the amount of added medetomidine-containing particles should be such that medetomidine constitutes at least 0.01% of the wet coating formulation by weight, or more preferably at least 0.1% of the wet coating formulation by weight. For example, medetomidine may constitute from 0.01 to 5%, from 0.01 to 2%, from 0.01 to 1%, from 0.01 to 0.5%, or from 0.01 to 0.2%; e.g., from 0.1 to 5%, from 0.1 to 2%, from 0.1 to 1%, from 0.1 to 0.5%, or from 0.1 to 0.2%, by weight of the wet coating formulation. The particle of the invention can be added to any type of antifouling coating formulation, but preferably to an FRC formulation, a CDP formulation or an SPC formulation. Even more preferred, the particle can be added to a silicon-based FRC formulation and/or a silyl acrylate-based SPC formulation.

The antifouling effect comprises prevention of barnacle settlement and possibly other types of hard fouling on the surface of the coating in which the medetomidine-containing particle is present.

### The Antifouling Coating

Also provided herein is an antifouling coating (or antifouling coating film), obtained by applying the wet antifouling coating formulation of the invention on a solid surface and allowing the formulation to dry on the surface. The coating formulation may be applied by any means, such as by spray coating, by brush, by roller etc. The obtained dry coating will generally have a thickness of about 0.05 mm to about 5 mm.

The antifouling coating of the invention is useful in a method for preventing aquatic (e.g., marine) biofouling. Therefore, a method for preventing marine biofouling of a surface is provided, comprising applying an antifouling coating formulation as defined herein to said surface or in the vicinity of said surface. In some embodiments, the method comprises applying the antifouling coating formulation to the surface. In some embodiments, the method comprises applying the antifouling coating formulation to an object in the vicinity of a surface, to provide an antifouling effect on the surface. In some embodiments, therefore, a method is provided wherein medetomidine will be released from an object carrying the antifouling coating of the invention when said object is immersed in the vicinity of a surface to be protected.

### The Coated Object

Also provided herein is an object having an antifouling coating as disclosed herein on at least part of a surface. The object may be any type of object prone to biofouling in contact with water, e.g., any type of object at least partly immersed in water, e.g., in sea water. In some embodiments, the object is or is part of a water vehicle, such as a boat or ship, an oil or gas off-shore installation, an aqua culture equipment, a marine sensor, or a floating device.

In comparison to the use of pure medetomidine in paint formulations or the use of the prior art particles described in U.S. Pat. No. 7,311,766, the use of the medetomidine-containing particle of the invention results in lower concentrations of free medetomidine in the wet paint. Thus, the probability of undesired interactions and/or reactions of medetomidine with other paint components is lower. As an example, the low levels of free medetomidine in the wet paint obtained according to the invention may extend the shelf life and improve in-can stability of paint containing binders with ester and/or silyl esters functional groups as part of the polymer chain. This is demonstrated by the data provided herein, showing the viscosity increase over time, i.e. gelling, of silyl acrylate-based formulations containing pure medetomidine and of corresponding formulations with medetomidine-containing particles according to the invention.

Another benefit of the invention comes with the fact that the medetomidine is more diluted as it comes together with a particle formulation. Hence, an error in dosage during paint production results in smaller percentual error of the medetomidine content compared to when pure medetomidine is used.

### EXAMPLES

The invention will be further illustrated in the following non-limiting Examples.

### Example 1. Medetomidine-Containing ZnO Particle

A solution of 14.00 g Zn (CH₃COO)₂·2H₂O in 90 mL of a liquid phase (50% by volume of H₂O and 50% by volume of CH₃OH) was slowly added to another solution containing 0.58 g medetomidine and 200 mL of liquid phase (50% by volume of H₂O and 50% by volume of CH₃OH). Thereafter, an NaOH solution (5.20 g NaOH, 50 mL H₂O) was added dropwise with the resulting formation of a white precipitate. The precipitate was separated from the liquid phase by vacuum filtration. The powder was washed several times with water and finally dried at room temperature. The obtained pigment particles contained up to 10% by weight of medetomidine.

### Reference Example 1. ZnO Particle

The method of Example 1 was followed, except for adding no medetomidine, to obtain a ZnO powder.

### Example 2. Medetomidine-Containing CuPT Particle

Medetomidine (0.60 g) was added to a solution of 2.98 g CuSO₄ and 400 mL water. Thereafter, a sodium pyrithione solution (12.67 g of 2-mercaptoppyridine-N-oxide, sodium salt, 40 wt. % aqueous solution, diluted with additional 100 mL H₂O) was added dropwise, resulting in a green precipitate. The precipitate was washed several times with water and finally dried at room temperature. The obtained pigment particles contained up to 10% by weight of medetomidine.

### Reference Example 2. CuPT Particle

The method of Example 2 was followed, except for adding no medetomidine, to obtain a CuPT powder.

### Example 3. Medetomidine-Containing BaSO₄ Particle

Medetomidine (0.75 g) was dissolved in 260 mL of a liquid phase (42% by volume of CH₃OH and 58% by volume of H₂O). Another solution consisting of 6.00 g BaCl₂ in 100 mL of a liquid phase (42% by volume of CH₃OH and 58% by volume of H₂O) was thereafter added to the medetomidine solution. Subsequently, an Na₂SO₄ solution (4.09 g Na₂SO₄, 143 mL of a liquid phase, 42% by volume of CH₃OH and 58% by volume of H₂O) was added dropwise, resulting in gradual formation of a white precipitate. The liquid phase was removed by decantation and evaporation at room temperature. The precipitate was washed several times with water and finally dried at room temperature. The obtained pigment particles contained up to 10% by weight of medetomidine.

### Reference Example 3. BaSO₄ Particle

The method of Example 3 was followed, except for adding no medetomidine, to obtain a BaSO₄ powder.

### Example 4. Silyl Acrylate-Based Antifouling Paint Formulations Containing Medetomidine Pigments Prepared by Co-Precipitation

Silyl acrylate-based paint formulations were prepared containing water-soluble binder (rosin), insoluble binder (silyl acrylate), water scavenger (tetraethyl orthosilicate, (TEOS)), biocide (Cu₂O), pigment (ZnO), and solvent (xylene), and additionally containing either: the medetomidine-containing pigment particles prepared in Examples 1-3, the “empty” pigment particles of Reference Examples 1-3, or pure medetomidine, or containing no such further addition.

All ingredients except for TEOS and the silyl acrylate solution were added to 125 mL paint cans and mixed together using a spatula. Thereafter the silyl acrylate solution and TEOS were added followed by mixing once again with a spatula. The paint cans were shaken in a paint can shaker for 5 minutes, until the paint components were homogenously distributed in the cans. The ingredients and amounts thereof (in g) in the prepared formulations (A-H) are indicated in Table 1, where formulations A, D, F, and H are reference formulations containing no medetomidine, formulation B is a comparative formulation, and formulations C, E, and G are in accordance with the invention.

TABLE 1

| Ingredient | A | B | C | D | E | F | G | H |
|---|---|---|---|---|---|---|---|---|
| Rosin solution⁽¹⁾ | 4.00 | 4.00 | 4.00 | 4.00 | 4.00 | 4.00 | 4.00 | 4.00 |
| TEOS | 3.60 | 3.60 | 3.60 | 3.60 | 3.60 | 3.60 | 3.60 | 3.60 |
| Silyl acrylate⁽²⁾ | 70.00 | 70.00 | 70.00 | 70.00 | 70.00 | 70.00 | 70.00 | 70.00 |
| Xylene | 16.40 | 16.40 | 16.40 | 16.40 | 16.40 | 16.40 | 16.40 | 16.40 |
| Cu₂O | 70.00 | 70.00 | 70.00 | 70.00 | 70.00 | 70.00 | 70.00 | 70.00 |
| ZnO | 10.00 | 10.00 | 5.00 | 5.00 | 5.00 | 5.00 | 5.00 | 5.00 |
| Medetomidine | | 0.50 | | | | | | |
| Ex. 1 | | | 5.00 | | | | | |
| Ref. Ex. 1 | | | | 5.00 | | | | |
| Ex. 2 | | | | | 5.00 | | | |
| Ref. Ex. 2 | | | | | | 5.00 | | |
| Ex. 3 | | | | | | | 5.00 | |
| Ref. Ex. 3 | | | | | | | | 5.00 |
| Total (g) | 174.00 | 174.50 | 174.00 | 174.00 | 174.00 | 174.00 | 174.00 | 174.00 |

⁽¹⁾65% in xylene,
⁽²⁾50% in xylene/butanol

It should be noted that a higher medetomidine concentration than what is typically used in antifouling paints was used here in order to accelerate the gelation test. Normally, about 0.1 wt. % medetomidine is enough to obtain an efficient barnacle protection.

The viscosity of the paint samples was measured using a Krebs Viscometer (TQC Sheen). The paint samples were shaken 5 minutes in a paint can shaker prior to the viscosity measurement to ensure homogenous distribution of the paint components.

### Comments on the Results:

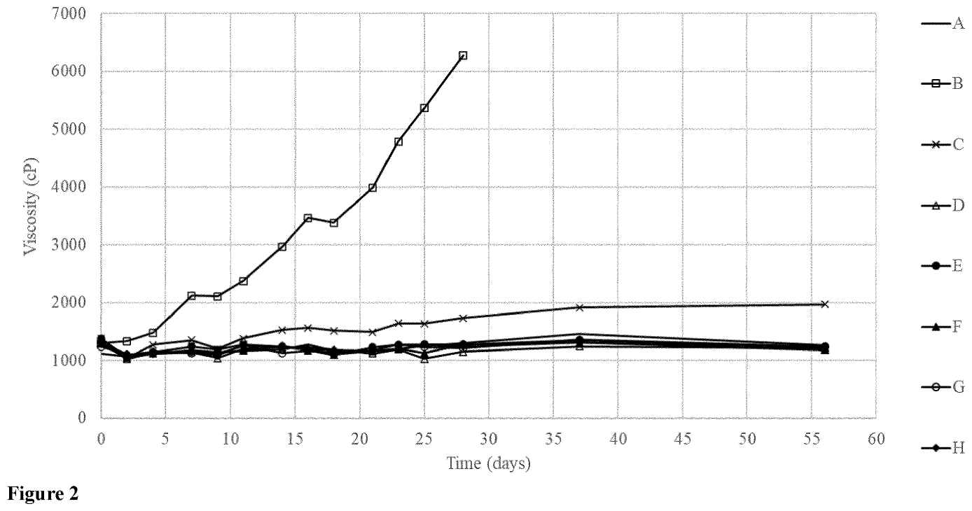

The results are illustrated in FIG. 2. By comparison of formulations A and B, it is obvious that free medetomidine promotes viscosity increase (gelation) of the silyl acrylate-based formulation. However, the results obtained for formulations C, E and G clearly show that incorporation of medetomidine within pigments efficiently mitigates gelation of silyl acrylate-based paint. Formulations E and G had not yet exhibited any significant gelation as of the inspection at 317 days after preparation whereas the viscosity of formulation C had increased to about 2000 cP after 56 days. This should however be compared to the reference formulation B, containing free medetomidine, which reached 2000 cP already 7 days after preparation. The mitigated gelation of formulations C, E and G is explained by the lower amount of free medetomidine in the wet paint formulations when using medetomidine incorporated within pigments. Hence, this invention offers a new method to formulate medetomidine-containing silyl acrylate-based paint with preserved or significantly extended shelf life. It should also be noted that the reference pigments without medetomidine (formulations D, F and H) had shown no impact on the silyl acrylate gelation as of the inspection 317 days after preparation.

### Example 5. Silyl Acrylate-Based Antifouling Paint Formulations Comparing Medetomidine Containing Pigments Prepared by Co-Precipitation and Adsorption

It is known in the prior art (U.S. Pat. No. 7,311,766) that the release rate of medetomidine from a coating can be controlled by pre-adsorbing medetomidine on the surface of a carrier particle, for example a ZnO particle. This example illustrates the differences of using the prior art method of pre-adsorbed medetomidine on the surface of ZnO particles and of using medetomidine incorporated within ZnO particles by co-precipitation, as described herein.

Silyl acrylate-based paint formulations were prepared containing water-soluble binder (rosin), insoluble binder (silyl acrylate), water scavenger (TEOS), biocide (Cu₂O), pigment (ZnO), and solvent (xylene), and additionally containing either: the medetomidine-containing pigment ZnO particles prepared in Example 1, medetomidine-carrying ZnO particles prepared by adsorption as described herein below, pure medetomidine, or containing no such further addition.

Adsorption of medetomidine on the surface of ZnO was performed by stirring medetomidine, solvent and ZnO in a closed conical flask at room temperature for 24 hours. The volume of solvent was 100 mL per 1.0 g medetomidine. The suspension was thereafter transferred into an uncovered beaker whereby the solvent was evaporated. The dry solids were pestled into a fine powder. The medetomidine was adsorbed either on commercial ZnO (White Seal, Umicore Zinc Chemicals, Larvik, Norway), on ZnO nanoparticles (particle diameter <100 nm, Sigma Aldrich, Stockholm, Sweden), or on ZnO particles prepared as in Reference Example 1. The adsorption was made either with xylene or with 1-methoxy-2-propanol as solvent and the final powders contained up to 10 wt. % medetomidine. The details of each prepared sample are indicated in Table 2.

All ingredients, except for TEOS and silyl acrylate solution, were added to 125 mL paint cans and mixed together using a spatula. Thereafter the silyl acrylate solution and TEOS were added followed by mixing once again with a spatula. The paint cans were shaken in a paint can shaker for 5 minutes, until the paint components were homogenously distributed in the cans. The ingredients and amounts thereof (in g) in the prepared formulations (I-O) are indicated in Table 2, where formulation I is a reference formulation containing no medetomidine, formulations J, L, M, N, and O are comparative formulations, and formulation K is a formulation according to the invention.

TABLE 2

| Ingredient | I | J | K | L | M | N | O |
|---|---|---|---|---|---|---|---|
| Rosin solution⁽¹⁾ | 4.00 | 4.00 | 4.00 | 4.00 | 4.00 | 4.00 | 4.00 |
| TEOS | 1.80 | 1.80 | 1.80 | 1.80 | 1.80 | 1.80 | 1.80 |
| Silyl acrylate⁽²⁾ | 70.00 | 70.00 | 70.00 | 70.00 | 70.00 | 70.00 | 70.00 |
| Xylene | 18.20 | 18.20 | 18.20 | 18.20 | 18.20 | 18.20 | 18.20 |
| Cu₂O | 70.00 | 70.00 | 70.00 | 70.00 | 70.00 | 70.00 | 70.00 |
| ZnO | 10.00 | 10.00 | 5.00 | 5.00 | 5.00 | 5.00 | 5.00 |
| Medetomidine | | 0.50 | | | | | |
| Ex. 1 | | | 5.00 | | | | |
| 10% medetomidine/ZnO | | | | 5.00 | | | |
| nanoparticles⁽³⁾ (prepared | | | | | | | |
| by adsorption in 1- | | | | | | | |
| methoxy-2-propanol) | | | | | | | |
| 10% medetomidine/ZnO | | | | | 5.00 | | |
| nanoparticles⁽³⁾ (prepared | | | | | | | |
| by adsorption in xylene) | | | | | | | |
| 10% | | | | | | 5.00 | |
| medetomidine/commercial | | | | | | | |
| ZnO⁽⁴⁾ (prepared by | | | | | | | |
| adsorption in xylene) | | | | | | | |
| 10% medetomidine/Ref. | | | | | | | 5.00 |
| Ex. 1-ZnO⁽⁵⁾ | | | | | | | |
| (prepared by adsorption in | | | | | | | |
| xylene) | | | | | | | |
| Total (g) | 174.00 | 174.50 | 174.00 | 174.00 | 174.00 | 174.00 | 174.00 |

⁽¹⁾65% in xylene,
⁽²⁾50% in xylene/butanol,
⁽³⁾ZnO nanoparticles (particle diameter <100 nm, Sigma Aldrich, Stockholm, Sweden),
⁽⁴⁾commercial ZnO (White Seal, Umicore Zinc Chemicals, Larvik, Norway),
⁽⁵⁾ZnO prepared as in Reference Example 1

It should be noted that a higher medetomidine concentration than what is typically used in antifouling paints was used here in order to accelerate the gelation test. Normally, about 0.1 wt. % medetomidine is enough to obtain an efficient barnacle protection.

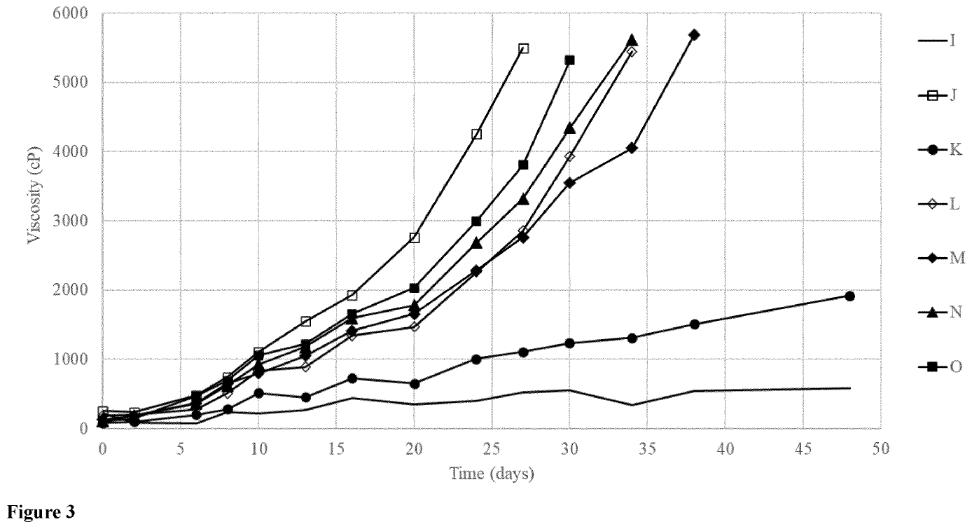

The viscosity of the paint samples was measured using a Krebs Viscometer (TQC Sheen). The paint samples were shaken 5 minutes in paint can shaker prior to the viscosity measurement to ensure homogenous distribution of the paint components. The results are illustrated in FIG. 3.

### Comments on the Results:

By comparison of formulations J and K in FIG. 3, it is obvious that the gelation of silyl acrylate paint can be significantly inhibited by using co-precipitated medetomidine/ZnO (as prepared in Example 1) instead of adding pure medetomidine. It is also possible to mitigate the gelation to some extent by using ready-made ZnO with pre-adsorbed medetomidine, see formulations L-O in FIG. 3. However, using co-precipitated medetomidine/ZnO (i.e. Example 1), as in formulation K, is by far the most efficient method to control the in-can viscosity of medetomidine-containing silyl acrylate-based paint. For example, after 30 days the viscosity of formulation K was about 1200 cP whereas the viscosity of the formulations prepared with medetomidine adsorbed on the surface ZnO (formulations L-O) ranged between 3500-5300 cP. This illustrates the large difference between particles carrying medetomidine adsorbed at the particle surface, as disclosed in U.S. Pat. No. 7,311,766, and particles of the present invention, having medetomidine incorporated within the particle matrix.

### Example 6. Silicone-Based FRC Antifouling Paint Formulation

The medetomidine-containing pigments of Examples 1-3 were added as an antifouling additive to a commercial silicone-based FRC paint (Hempel Silic One Topcoat). For comparison, the commercial silicone-based FRC paint was admixed with the “empty” pigments of Reference Examples 1-3, or with a medetomidine solution (medetomidine/1-methoxy-2-propanol), or was used without any of the mentioned additives. For each paint formulation, the components were weighed in 125 mL paint cans and were thereafter shaken in a paint can shaker for 5 minutes, i.e. until the paint components were homogenously distributed.

The ingredients and amounts thereof (in g) in the prepared formulations (P-W) are indicated in Table 3, where formulations P, S, U, and W are reference formulations containing no medetomidine, formulation Q is a comparative formulation, and formulations R, T, and V are in accordance with the invention.

TABLE 3

| Ingredient | P | Q | R | S | T | U | V | W |
|---|---|---|---|---|---|---|---|---|
| Hempel | 40.00 | 40.00 | 40.00 | 40.00 | 40.00 | 40.00 | 40.00 | 40.00 |
| Silic One | | | | | | | | |
| Topcoat | | | | | | | | |
| Medetomi- | | 0.20 | | | | | | |
| dine⁽¹⁾ | | | | | | | | |
| Ex. 1 | | | 0.40 | | | | | |
| Ref. Ex. 1 | | | | 0.40 | | | | |
| Ex. 2 | | | | | 0.40 | | | |
| Ref. Ex. 2 | | | | | | 0.40 | | |
| Ex. 3 | | | | | | | 0.40 | |
| Ref. Ex. 3 | | | | | | | | 0.40 |
| Total | 40.00 | 40.20 | 40.40 | 40.40 | 40.40 | 40.40 | 40.40 | 40.40 |

⁽¹⁾20% solution in 1-methoxy-2-propanol

The topcoats were applied in two layers by brush on poly(methyl methacrylate) (PMMA) panels pre-coated with Hempel Light Primer and Hempel Silic One Tiecoat. The fully cured 5 topcoats were divided into three separate sections of which one was left undamaged, one was crosscut with a knife, and one was roughened with sandpaper.

Antifouling tests were performed by submersion of the treated panels in sea water for a prolonged period of time at the test site of Tjärnö (Sweden). All panels were submerged in June. The panels were inspected regularly and the barnacle fouling was visually assessed according to the scale indicated in Table 4.

TABLE 4

| | Visual assessment criterion |
|---|---|
| Overall antifouling | |
| efficiency rating | |
| Poor | >10% of surface covered by barnacles |
| Fair | 3-10% of surface covered by barnacles |
| Good | 0-3% of surface covered by barnacles |
| Excellent | No barnacles |
| Crosscut antifouling | |
| efficiency rating | |
| OK | No barnacles in crosscut |
| Not OK | Barnacles in crosscut |

Table 5 show the results, in terms of antifouling rating, after 71 and 150 days, respectively, of submersion of the treated panels in the sea at Tjärnö.

TABLE 5

| | 71 days of submersion | | | 150 days of submersion | | |
|---|---|---|---|---|---|---|
| | Un- | | | Un- | | |
| Formulation | damaged | Crosscut | Sanded | damaged | Crosscut | Sanded |
| P | Excellent | Not OK | Good | Excellent | Not OK | * |
| Q | Excellent | Not OK | Fair | Excellent | Not OK | * |
| R | Excellent | OK | Excellent | Excellent | OK | Excellent |
| S | Excellent | Not OK | Fair | Excellent | OK | Fair |
| T | Excellent | OK | Excellent | Excellent | OK | Excellent |
| U | Excellent | Not OK | Good | Excellent | OK | Good |
| V | Excellent | Not OK | Fair | Good | OK | Good |
| W | Excellent | Not OK | Fair | Good | Not OK | * |

* Not possible to evaluate barnacle coverage due to heavy fouling by other species.

### Comments on the Results:

The results show that silicone-based FRC are sensitive to damage, e.g., abrasion and scratches. The coating obtained using reference formulation P, i.e. Hempel Silic One Topcoat without any addition, was fouled by barnacles on the sanded area and in the knife cut. Hence, whereas undamaged silicone-based FRC may be effective against barnacle growth, damaged areas of such coatings are easily fouled by barnacles.

The coating obtained using comparative formulation Q was also fouled by barnacles on the damaged areas. The reasonable explanation for this is fast release of the medetomidine as the coating was submerged in water. This is not unusual when medetomidine is added late in the paint making process, since there are then less adsorptions sites available for medetomidine on other paint components.

The coatings obtained using inventive formulations R and T provided excellent barnacle protection of damaged FRC. This implies that the medetomidine was released slowly during the period of seawater submersion. It also means that this type of medetomidine containing particle is suitable for post-addition to ready-made paint without risk of premature depletion of medetomidine from the coating. No or very limited barnacle antifouling effect was observed for the coating obtained using inventive formulation V and for coatings obtained using the reference formulations S, U and W.

### Example 7. Rosin-Based Paint Formulation

Rosin-based paint formulations were prepared containing water-soluble binder (rosin), insoluble binder (Poly (butyl methacrylate-co-methyl methacrylate) (PBMA)), plasticizer (Phosphlex® 71B), pigment (ZnO), rheological additive (Bentone SD1®), thickener (fumed silica), filler (BaSO₄), and solvent (xylene), and additionally containing either: the medetomidine-containing pigments of Examples 1-3 as an antifouling additive, the “empty” pigments of Reference Examples 1-3, or a medetomidine solution (medetomidine/1-methoxy-2-propanol), or containing no such additions. For each formulation, the ingredients were weighed in 125 mL paint cans together with 10 mL of ceramic beads. The paint cans were shaken in a paint can shaker for 5 minutes, i.e. until the paint components were homogenously distributed. The compositions of the thus prepared formulations (X-AE) are indicated in Table 6, where formulations X, AA, AC, and AE are reference formulations containing no medetomidine, formulation Y is a comparative formulation, and formulations Z, AB, and AD are in accordance with the invention.

TABLE 6

| Ingredient | X | Y | Z | AA | AB | AC | AD | AE |
|---|---|---|---|---|---|---|---|---|
| Rosin ⁽¹⁾ | 12.65 | 12.65 | 12.65 | 12.65 | 12.65 | 12.65 | 12.65 | 12.65 |
| PBMA ⁽²⁾ | 10.33 | 10.33 | 10.33 | 10.33 | 10.33 | 10.33 | 10.33 | 10.33 |
| Phosflex ® 71B ⁽³⁾ | 3.50 | 3.50 | 3.50 | 3.50 | 3.50 | 3.50 | 3.50 | 3.50 |
| ZnO | 4.20 | 4.20 | 4.20 | 4.20 | 4.20 | 4.20 | 4.20 | 4.20 |
| Bentone SD1 ® ⁽⁴⁾ | 0.80 | 0.80 | 0.80 | 0.80 | 0.80 | 0.80 | 0.80 | 0.80 |
| Fumed silica | 0.35 | 0.35 | 0.35 | 0.35 | 0.35 | 0.35 | 0.35 | 0.35 |
| BaSO₄ | 31.80 | 31.80 | 31.80 | 31.80 | 31.80 | 31.80 | 31.80 | 31.80 |
| CuPT | 0.80 | 0.80 | 0.80 | 0.80 | 0.80 | 0.80 | 0.80 | 0.80 |
| Xylene | 15.00 | 15.00 | 15.00 | 15.00 | 15.00 | 15.00 | 15.00 | 15.00 |
| Medetomidine ⁽⁵⁾ | | 0.40 | | | | | | |
| Ex. 1 | | | 0.80 | | | | | |
| Ref. Ex. 1 | | | | 0.80 | | | | |
| Ex. 2 | | | | | 0.80 | | | |
| Ref. Ex. 2 | | | | | | 0.80 | | |
| Ex. 3 | | | | | | | 0.80 | |
| Ref. Ex. 3 | | | | | | | | 0.80 |
| Total | 79.43 | 79.83 | 79.43 | 79.43 | 79.43 | 79.43 | 79.43 | 79.43 |

⁽¹⁾ 65% solution in xylene,
⁽²⁾ 35% solution in xylene,
⁽³⁾ from ICL Industrial Products Ltd, Beer Sheva, Israel,
⁽⁴⁾ from Elementis GmbH, Cologne, Germany,
⁽⁵⁾ 20% solution in 1-methoxy-2-propanol

The paint was applied with a wet film thickness of 150 μm on PMMA panels and antifouling tests were performed by submersion of the treated panels in sea water for a prolonged period of time at Tjärnö test site (Sweden). All panels were submerged in the month of June. Panels were inspected regularly and the barnacle fouling was visually assessed. Overall antifouling efficiency of the formulations was rated according to the scale indicated in Table 4. Table 7 shows the results after 71, 287 and 449 days of submersion of the panels at Tjärnö test site.

TABLE 7

| Formulation | 71 days | 287 days | 449 days |
|---|---|---|---|
| X | Fair | Fair | Poor |
| Y | Excellent | Excellent | Excellent |
| Z | Excellent | Excellent | Excellent |
| AA | Good | Good | Poor |
| AB | Excellent | Excellent | Excellent |
| AC | Poor | Poor | Poor |
| AD | Good | Good | Poor |
| AE | Poor | Poor | Poor |

### Comments on the Results:

An addition of medetomidine to rosin-based paint provides excellent barnacle protection. This is obvious by comparing panels coated with formulation X (containing no medetomidine) and with formulation Y (containing medetomidine). Note that formulation Y was prepared by adding medetomidine as a solution early in the paint making processes. It is therefore probable that the medetomidine was adsorbed on another paint component, for instance a pigment. Adsorption of medetomidine on the surface of a pigment in the paint is known to facilitate slow release of medetomidine and efficient barnacle fouling protection.

The results in Table 7 also show that addition of medetomidine-containing particles prevents or make it significantly more difficult for barnacles to attach on the coating surface. Medetomidine incorporated within ZnO or CuPT (formulations Z and AB) gives an antifouling effect comparable to when medetomidine is added as a solution at an early formulation stage (formulation Y). The BaSO₄-based particle (formulation AD) was less efficient. The corresponding particles without medetomidine (formulation AA, AC, AE) were less or not at all active against barnacles. From the results, it is concluded that the medetomidine-containing particle of the invention generally provides an effective protection against barnacle settling on the surfaces of rosin-based coatings.

### Example 8. Medetomidine-Containing Cu₂O Particle

A solution of 20 mL H₂O, 2.146 g citric acid, 0.288 g CuSO₄·5H₂O and 1.341 g NaOH was stirred for 5 min. Thereafter, a solution of 20 mL H₂O and 1.667 g Na₂CO₃ was added to the previously mentioned solution. A solution containing 6.600 g sucrose, 20 mL H₂O and 1.000 g citric acid was heated in a boiling water bath for 10 min, and then cooled down to room temperature to be added to the solution containing CuSO₄·5H₂O. Thereafter, 0.026 g medetomidine was dissolved in 10 mL CH₃OH, and 10 mL H₂O was then added; the medetomidine solution was added to the solution containing CuSO₄·5H₂O, which was then put into a boiling water bath for 15 min. Thereafter, 20 mL 0.5 M NaOH was added dropwise to the CuSO₄·5H₂O solution until the color of the solution changed from blue to orange. The solution was left in the water bath for 5 min after the color change, and then added to Falcon® tubes to be centrifuged for 30 min at 4000 rpm. The supernatant was poured off, and 40 mL H₂O was added to each tube to wash the co-precipitate. The Falcon® tubes were then centrifuged utilizing the same procedure. The supernatant was poured off, and the co-precipitate was extracted from the tubes and put on filter paper to dry at room temperature. 10% of the final product was dissolved in 1 g CH₃OH and shaken for 10 min and left on a roller table for 1 hour. The sample was then centrifuged, and the supernatant was extracted and examined by gas chromatography which showed that medetomidine was present in the sample.

1. A solid particle comprising a coprecipitate of:
(i) a metal or metalloid compound, and
(ii) medetomidine or an enantiomer or salt of medetomidine.

2. The particle of claim 1, wherein said metal or metalloid compound has a water solubility at pH 7 and 20° C. of from 0.01 to 150 mg/L, preferably from 0.01 mg/L to 100 mg/L, more preferably from 0.01 mg/L to 50 mg/L, even more preferably from 0.01 to 10 mg/L, and most preferably from 0.01 to 5 mg/L.

3. The particle of claim 1, wherein the metal in said metal compound is selected from Mg, Ca, Ti, Fe, Cu, Zn, Al and Ba, and the metalloid in said metalloid compound is Si.

4. The particle of claim 1, wherein said metal or metalloid compound is a metal or metalloid oxide, a metal or metalloid salt, or a metal or metalloid coordination complex, preferably selected from zinc (II) oxide, iron (II) oxide, iron (III) oxide, copper (I) oxide, copper (II) oxide, titanium (IV) oxide, silicon (IV) oxide, copper (II) pyrithione, zinc (II) pyrithione, copper (I) thiocyanate, barium (II) sulfate, calcium (II) sulfate, magnesium (II) carbonate, calcium (II) carbonate, barium (II) carbonate, iron (II) carbonate, zinc (II) carbonate, and metal salts of C2-C24 carboxylic acids; more preferably selected from zinc (II) oxide, copper (I) oxide, copper (II) pyrithione, and barium (II) sulfate.

5. The particle of claim 1, comprising 1 to 50% by weight of the medetomidine or the enantiomer or salt of medetomidine, preferably 5 to 15% by weight of the medetomidine or the enantiomer or salt of medetomidine.

6. A method for preparing the solid particle of claim 1, by coprecipitation of (i) a metal or metalloid compound, and (ii) medetomidine or an enantiomer or salt of medetomidine.

7. The method of claim 6, comprising:
admixing two liquid phase solutions of different salts in the presence of medetomidine or an enantiomer or salt of medetomidine, to form a metal or metalloid compound having a lower solubility in the liquid phase than either of the different salts; and
allowing said metal or metalloid compound and said medetomidine or enantiomer or salt of medetomidine to coprecipitate from the obtained liquid mixture.

8. The method of claim 7, wherein said medetomidine or enantiomer or salt of medetomidine is present as a solute in at least one of said liquid phase solutions.

9. The method of claim 6, comprising separating the coprecipitate from the liquid phase and optionally drying the separated coprecipitate.

10. An antifouling additive comprising a solid particle comprising a coprecipitate of,
(i) a metal or metalloid compound, and
(ii) medetomidine or an enantiomer or salt of medetomidine,
or as prepared in claim 6, and optionally a liquid carrier.

11. An antifouling coating formulation containing a solid particle comprising a coprecipitate of:
(i) a metal or metalloid compound, and
(ii) medetomidine or an enantiomer or salt of medetomidine,
or as prepared in claim 6, and a surface coating material.

12. The antifouling coating formulation of claim 11, wherein the formulation contains the particle in an amount sufficient to provide a medetomidine content in the formulation of at least 0.01% by weight, preferably at least 0.1% by weight, by weight of the formulation.

13. An antifouling coating film formed from an antifouling coating formulation as defined in claim 11.

14. A method for preventing marine biofouling of a surface by applying an antifouling coating formulation as defined in claim 11 to said surface or in the vicinity of said surface.
